(19) United States
(12) Patent Application Publication
(10) Pub. No.: US 2014/0043697 A1
(43) Pub. Date: Feb. 13, 2014

(54) Imaging Lens

(71) Applicants: Kuo-Yu LIAO, Taichung (TW); Chao Hsiang Yang, Taichung (TW)

(72) Inventors: Kuo-Yu LIAO, Taichung (TW); Chao Hsiang Yang, Taichung (TW)

(73) Assignee: Ability opto-electronics technology co., ltd, Taichung (TW)

(21) Appl. No.: 13/933,567

(22) Filed: Jul. 2, 2013

(30) Foreign Application Priority Data
Jul. 2, 2012 (TW) 101123675

(51) Int. Cl. G02B 13/00

(52) U.S. Cl. CPC G02B 13/004
USPC 359/715; 359/772; 359/723

(57) ABSTRACT

A thin imaging lens assembly with four lenses, having one defined as an object side and an opposite end defined as an image side, and comprising: a lens set, including a first lens, a second lens, a third lens, and a fourth lens that are arranged from the object side to the image side in sequence so as to form an optical structure; and a fixed aperture, deposited between the object side and the image side, wherein the first lens has a positive refractive power around an optical axis thereof; the second lens has a negative refractive power around an optical axis thereof; the third lens has a positive refractive power around an optical axis thereof; and the fourth lens comprises a seventh surface, a convex surface around an optical axis thereof, and an eighth surface, a wavy and concave surface around an optical axis thereof.

### BACKGROUND OF THE INVENTION

1. Technical Field

The present invention relates to imaging devices, and more particularly to a thin imaging lens assembly with four lenses that provides high-resolution images with its designed lens curvatures, lens intervals and other optical parameters.

2. Description of Related Art

Imaging lens sets now can be extensively seen in many electronic products, such as mobile phone, laptop computers and webcams. With the trend of these electronic products toward high compactness, high lightness and high performance, image sensors in such imaging lens sets, which are typically a charge-coupled device (CCD) or a complementary metal-oxide semiconductor (CMOS), have been developed to support more pixels, with their lens structures becoming more and more compact. Thus, there is a need existing for an improved lens structure of complex imaging devices, such as a thin imaging lens assembly with four lenses proposed herein by the present invention.

### SUMMARY OF THE INVENTION

A primary objective of the present invention is to provide a thin imaging lens assembly with four lenses that comprises four lenses and features high compactness as well as high resolution.

A secondary objective of the present invention is to provide a thin imaging lens assembly with four lenses that is structurally compacter yet displays better imaging performance as compared to the prior-art devices.

A further objective of the present invention is to provide a thin imaging lens assembly with four lenses that has a lens structure suitable for microminiaturized imaging units used in various electronic products incorporating optical and video functions, including mobile phones, smartphones, PCCAMs, laptop computers and so on.

To achieve the above and other objects, the present invention discloses a thin imaging lens assembly with four lenses, having one defined as an object side and an opposite end defined as an image side, and comprising: a lens set, including a first lens, a second lens, a third lens, and a fourth lens that are arranged from the object side to the image side in sequence so as to form an optical structure; and a fixed aperture, deposited between the object side and the image side, wherein the first lens has a positive refractive power around an optical axis thereof and comprises a first surface and a second surface, in which the first surface and the second surface are curved surfaces facing the object side and the image side, respectively, while the second surface is concave surface around an optical axis thereof; the second lens has a negative refractive power around an optical axis thereof and comprises a third surface and a fourth surface, in which the third surface and the fourth surface are curved surfaces facing the object side and the image side, respectively, while the fourth surface is a convex surface around an optical axis thereof; the third lens has a positive refractive power around an optical axis thereof and comprises a fifth surface and a sixth surface, in which the fifth surface and the sixth surface are curved surfaces facing the object side and the image side, respectively, while the fifth surface is a concave surface around an optical axis thereof; and the fourth lens comprises a seventh surface and an eighth surface, in which the seventh surface and eighth surface are curved surface facing the object side and the image side, respectively, while the seventh surface is a convex surface around an optical axis thereof and the eighth surface is wavy and is concave around an optical axis thereof.

In the said thin imaging lens assembly with four lenses, each of the first lens, the second lens, the third lens and the fourth lens has at least one said surface being an aspherical surface.

In the said thin imaging lens assembly with four lenses, the aspherical curved surface satisfies a definition expressed by the following equation:

$$z = \frac{{ch}^{2}}{1 + {[ 1 - ( k + 1 ) {c}^{2} {h}^{2} ]}^{0.5}} + A {h}^{4} + {Bh}^{6} + {Ch}^{8} + {Dh}^{10} + {Eh}^{12} + {Fh}^{14} + {Gh}^{16} + …$$

where z represents a location value at an altitude h determined against a surface zenith as a reference along optic axis, k is a conic constant, c is a reciprocal of the radius of curvature, and A, B, C, D, E, F and G are high-order aspherical coefficients.

In the said thin imaging lens assembly with four lenses, each of the first lens, the second lens, the third lens and the fourth lens has at least one said surface being a spherical curved surface.

In the said thin imaging lens assembly with four lenses, the first surface of the first lens is a convex surface around the optical axis thereof, and radius of curvatures of the first surface and the second surface are such configured that the first lens has the positive refractive power around the optical axis thereof.

In the said thin imaging lens assembly with four lenses, the third surface of the second lens is a concave surface around the optical axis thereof, and radius of curvatures of the third surface and the fourth surface are such configured that the second lens has the negative refractive power around the optical axis thereof.

In the said thin imaging lens assembly with four lenses, the sixth surface of the third lens is a convex surface around the optical axis thereof, and radius of curvatures of the fifth surface and the sixth surface are such configured that the third lens has the positive refractive power around the optical axis thereof.

In the said thin imaging lens assembly with four lenses, a focal length of the entire lens set is f, and a distance between the first surface of the first lens and the image side is TL, in which 0.5<f/TL<1.

In the said thin imaging lens assembly with four lenses, the image side is an image sensor that is an optical image sensing device made of a charge-coupled device or a complementary metal-oxide semiconductor for sensing optical image signals transmitted by the lens set, and 0.5<TL/Dg<1, in which Dg is defined as a diagonal length of a maximum using visual angle of the lens assembly imaged on the image side.

In the said thin imaging lens assembly with four lenses, further comprising a filter this is a band-pass optical lens and located between the object side and the image side.

In the said thin imaging lens assembly with four lenses, further comprising a filter, which is a band-pass optical lens and deposited at one side of the fourth lens facing the image side.

In the said thin imaging lens assembly with four lenses, the fixed aperture is deposited on one of the surfaces of one of the lenses.

### BRIEF DESCRIPTION OF THE SEVERAL VIEWS OF THE DRAWINGS

The objects as well as the technical features and effects of the present invention will be best understood by referring to the following detailed description of some illustrative embodiments and the accompanying drawings, in which:

FIG. 1 is a schematic drawing of a thin imaging lens assembly with four lenses according to a first preferred embodiment of the present invention;

FIG. 2 graphs the optical distortion of the preferred embodiment of the present invention made according to the parameters listed in Table 1;

FIG. 3 graphs the field curvatures of the preferred embodiment of the present invention made according to the parameters listed in Table 1;

FIG. 4 graphs the optical aberration of the preferred embodiment of the present invention made according to the parameters listed in Table 1;

FIG. 5 depicts the structure of the second preferred embodiment of the disclosed thin imaging lens assembly with four lenses;

FIG. 6 graphs the optical distortion of the preferred embodiment of the present invention made according to the parameters listed in Table 3;

FIG. 7 graphs the field curvatures of the preferred embodiment of the present invention made according to the parameters listed in Table 3;

FIG. 8 graphs the optical aberration of the preferred embodiment of the present invention made according to the parameters listed in Table 3;

FIG. 9 depicts the structure of the third preferred embodiment of the disclosed thin imaging lens assembly with four lenses;

FIG. 10 graphs the optical distortion of the preferred embodiment of the present invention made according to the parameters listed in Table 5;

FIG. 11 the field curvatures of the preferred embodiment of the present invention made according to the parameters listed in Table 5; and

FIG. 12 graphs the optical aberration of the preferred embodiment of the present invention made according to the parameters listed in Table 5.

### DETAILED DESCRIPTION OF THE INVENTION

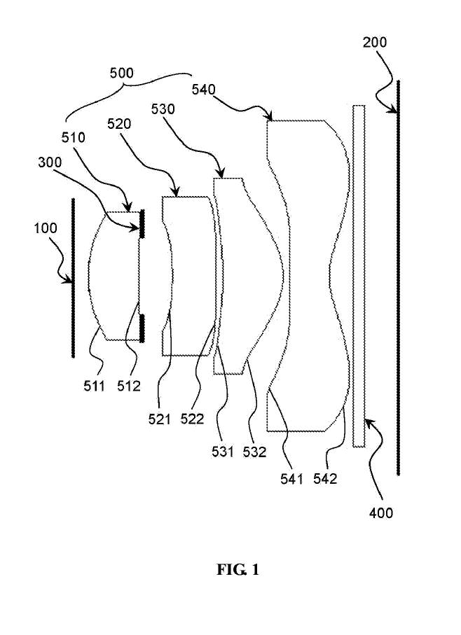

For better illustrating the present invention, some embodiments are herein described. FIG. 1 is a schematic drawing of a thin imaging lens assembly with four lenses according to a first preferred embodiment of the present invention. Referring to FIG. 1, the disclosed thin imaging lens assembly with four lenses comprises a lens set. The thin imaging lens assembly with four lenses (500) has one end defined as an object side (100) and an opposite end defined as an image side (200). The lens set (500) is composed of a plurality of optical lenses, including at least a first lens (510), a second lens (520), a third lens (530) and a fourth lens (540). These lenses are arranged from the object side (100) to the image side (200) in sequence so as to form an optical structure. Thereby, an object beam entering from the object side (100) can pass through the lens set (500) and be imaged at the image side (200).

Referring to FIG. 1 again, the disclosed thin imaging lens assembly with four lenses further comprises a fixed aperture (300) that is located between the object side (100) and the image side (200).

In addition, the disclosed thin imaging lens assembly with four lenses may further comprise a filter (400), which is a band-pass optical lens and located at a side of the fourth lens (540) facing the image side (200).

In the thin imaging lens assembly with four lenses as described above, after entering from the object side (100), an object beam passes through the lens set (500) during which process it also passes through the fixed aperture (300) and the filter (400), and then gets imaged at the image side (200).

According to the present embodiment, in the lens set (500) of the disclosed thin imaging lens assembly with four lenses, the first lens (510) has a positive refractive power around an optical axis thereof and includes a first surface (511) and a second surface (512). The first surface (511) and the second surface (512) face are curved surfaces face the object side (100) and the image side (200), respectively. The second surface (512) is a concave surface around an optical axis thereof. The second lens (520) has a negative refractive power around an optical axis thereof and comprises a third surface (521) and a fourth surface (522). The third surface (521) and the fourth surface (522) are curved surfaces facing the object side (100) and the image side (200), respectively. The fourth surface (522) is a convex surface around an optical axis thereof. The third lens (530) has a positive refractive power around an optical axis thereof and comprises a fifth surface (531) and a sixth surface (532). The fifth surface (531) and the sixth surface (532) are curved surfaces facing the object side (100) and the image side (200), respectively. The fifth surface (531) is a concave surface around an optical axis thereof. At last, the fourth lens (540) comprises a seventh surface (541) and an eighth surface (542). The seventh surface (541) and eighth surface (542) are curved surfaces facing the object side (100) and the image side (200), respectively. The seventh surface (541) is a convex surface around an optical axis thereof, and the eighth surface (542) is a wavy surface that is concave around an optical axis thereof around its optic axis.

According to the present embodiment, in the lens set (500) of the disclosed thin imaging lens assembly with four lenses, each of the first lens (510), the second lens (520), the third lens (530) and the fourth lens (540) has at least one surface is aspherical.

In the embodiment of the disclosed thin imaging lens assembly with four lenses, the fixed aperture (300) may be deposited: close to the first lens (510) and facing the object side (100); between the first lens (510) and the second lens (520), between the second lens (520) and the third lens (530); between the third lens (530) and the fourth lens (540); between the fourth lens (540) and the filter (400); between the filter (400) and the image side (200); or on one surface of any of these lenses.

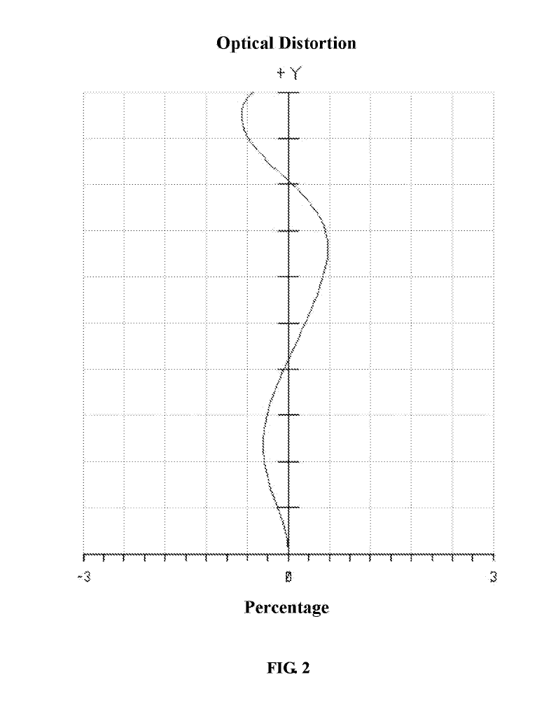

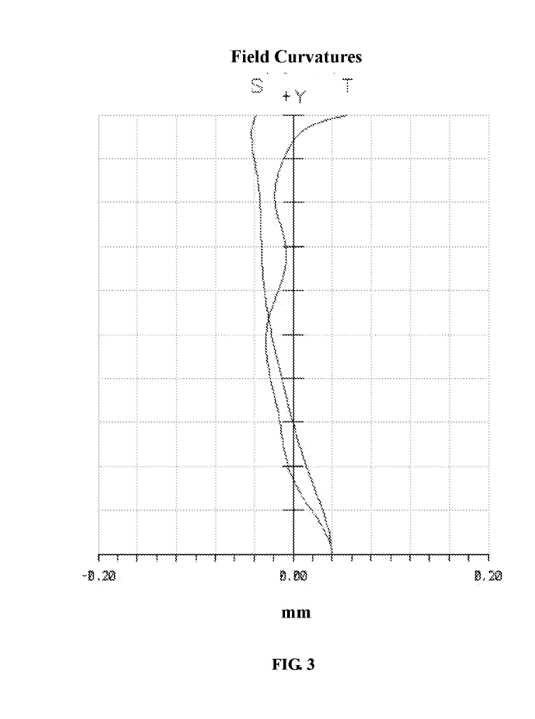

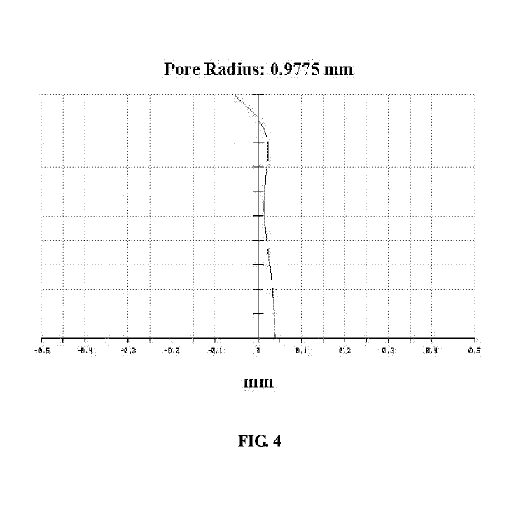

Table 1 shows the lens parameters and performance indexes of the thin imaging lens assembly with four lenses according to the first preferred embodiment of the present invention. FIG. 2 graphs the optical distortion of the preferred embodiment of the present invention made according to the parameters listed in Table 1. FIG. 3 graphs the field curvatures of the preferred embodiment of the present invention made according to the parameters listed in Table 1. FIG. 4 graphs the optical aberration of the preferred embodiment of the present invention made according to the parameters listed in Table 1. Referring to Table 1 and again FIG. 1, with the aforementioned configuration, in a further embodiment of the disclosed thin imaging lens assembly with four lenses, the fixed aperture (300) may be further deposited between the second surface (512) of the first lens (510) and the third surface (521) of the second lens (520). Therein, the first surface (511) of the first lens (510) is selected to be a convex surface around an optical axis thereof, while the second surface (512) is selected to be a concave surface around the optical axis thereof, so that the first lens (510) has a positive refractive power around the optical axis thereof. The third surface (521) of the second lens (520) is selected to be a concave surface around an optical axis thereof, while the fourth surface (522) of the second lens (520) is selected to be a convex surface around the optical axis thereof, so that the second lens (520) has a negative refractive power around the optical axis thereof. Meanwhile, the fifth surface (531) of the third lens (530) is selected to be a concave surface around the optical axis thereof, and the sixth surface (532) of the third lens (530) is selected to be a convex surface around an optical axis thereof, so that the third lens (530) has a positive refractive power around the optical axis. In addition, the seventh surface (541) of the fourth lens (540) is selected to be a convex surface around the optical axis thereof, and the eighth surface (542) of the fourth lens (540) is a wavy surface that is concave around the optical axis thereof around its optic axis. According to a second preferred embodiment of the present invention, in the disclosed thin imaging lens assembly with four lenses, the lenses forming the lens set (500) have their surfaces made with certain measures in terms of radius of curvature, thickness, interval, refractive index and Abbe number as shown in Table 1.

According to the above-mentioned embodiments, one of the first surface (511) and the second surface (512) in the first lens (510), one of the third surface (521) and the fourth surface (522) in the second lens (520), one of the fifth surface (531) and the sixth surface (532) in the third lens (530), and one of the seventh surface (541) and the eighth surface (542) in the fourth lens (540) are selected to be aspherical curved surfaces that satisfy a definition expressed by the following equation:

$$z = \frac{{ch}^{2}}{1 + {[ 1 - ( k + 1 ) {c}^{2} {h}^{2} ]}^{0.5}} + A {h}^{4} + {Bh}^{6} + {Ch}^{8} + {Dh}^{10} + {Eh}^{12} + {Fh}^{14} + {Gh}^{16} + …$$

where z represents a location value at an altitude h determined against a surface zenith as a reference along optic axis, k is a conic constant, c is a reciprocal of the radius of curvature, and A, B, C, D, E, F and G are all high-order aspherical coefficients.

Table 2 shows the surface parameters of the preferred embodiment of the present invention made according to the measurements as set forth in Table 1. Please refer to Table 2 for the definition of the aspherical curved surfaces of the foregoing thin imaging lens assembly with four lenses. More particularly, the aspherical coefficients are selected to have 16 as the highest order, so that the lens set of the disclosed thin imaging lens assembly with four lenses can realize the preferred embodiment as defined in Table 1.

Therefore, referring to FIG. 2, FIG. 3 and FIG. 4, according to the preferred embodiment defined by the parameters as summarized in Table 1 and Table 2, the disclosed thin imaging lens assembly with four lenses is enhanced in terms of optical distortion, field curvature and optical aberration.

Referring to FIG. 1 again, according to a further embodiment of the disclosed thin imaging lens assembly with four lenses, the lens set (500) has an entire focal length defined as f, and a distance between the first surface (511) of the first lens (510) and the image side (200) is defined as TL, wherein preferably 0.5<f/TL<1, so as to achieve the optimal imaging performance.

Additionally, the image side (200) is an image sensor that is an optical image sensing device for sensing optical image signals transmitted by the lens set (500). The image sensor may be a charge-coupled device (CCD) or a complementary metal-oxide semiconductor (CMOS). A diagonal length of a maximum using visual angle of the lens assembly imaged on the image side (200) is defined Dg, and when 0.5<TL/Dg<1, the optimal imaging performance can be achieved.

For the preferred embodiment of the disclosed thin imaging lens assembly with four lenses made in accordance with the parameters listed in Table 1 and Table 2, these parameters are:

f=4.71 mm

TL=6.31 mm

Dg=7.14 mm

f/TL=0.75

TL/Dg=0.88

By combining the optical parameters, focal length ratios and geometric parameter ratios of the lenses appropriately, the optimal imaging performance can be achieved.

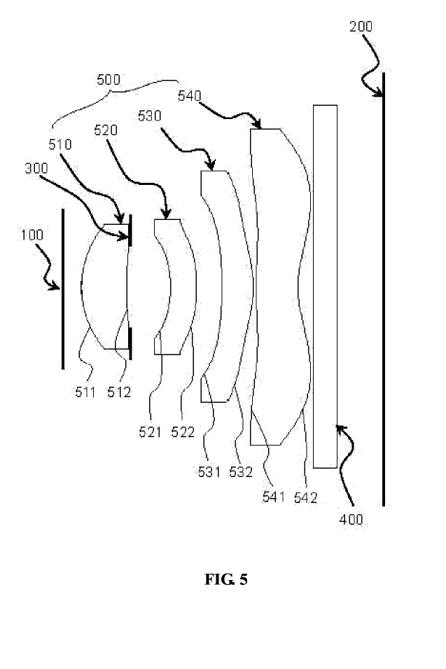

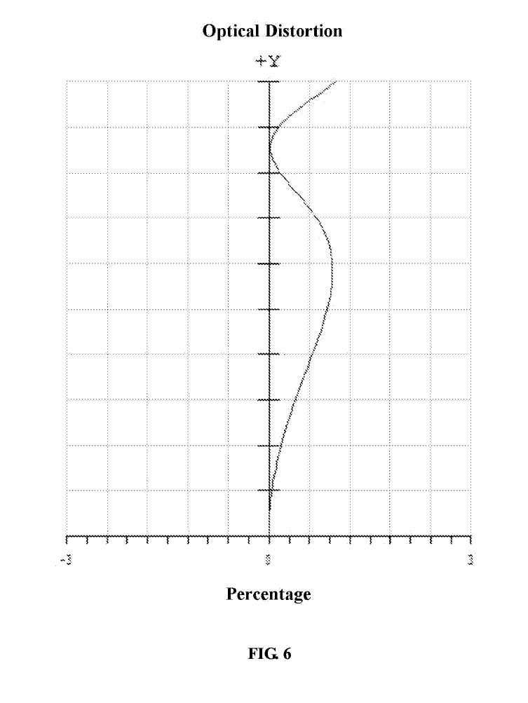

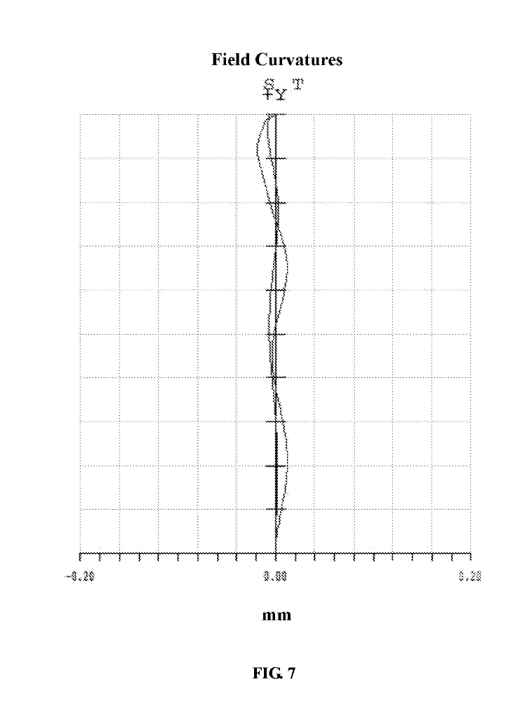

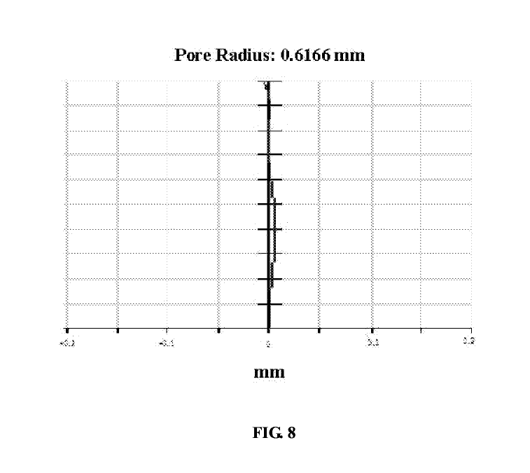

Table 3 shows lens parameters and performance indexes of the second preferred embodiment of the disclosed thin imaging lens assembly with four lenses. FIG. 5 depicts the structure of the second preferred embodiment of the disclosed thin imaging lens assembly with four lenses. FIG. 6 graphs the optical distortion of the preferred embodiment of the present invention made according to the parameters listed in Table 3. FIG. 7 graphs the field curvatures of the preferred embodiment of the present invention made according to the parameters listed in Table 3. FIG. 8 graphs the optical aberration of the preferred embodiment of the present invention made according to the parameters listed in Table 3. Referring to Table 3 and FIG. 5, according to a further embodiment of the disclosed thin imaging lens assembly with four lenses, the fixed aperture (300) may be deposited between the second surface (512) of the first lens (510) and the third surface (521) of the second lens (520), in which the first surface (511) of the first lens (510) is selected to be a convex surface around the optical axis thereof, and the second surface (512) is selected to be a concave surface around the optical axis thereof, so that the first lens (510) has a positive refractive power around the optical axis thereof. The third surface (521) of the second lens (520) is selected to be a concave surface around the optical axis thereof, and the fourth surface (522) of the second lens (520) is selected to be a convex surface around the optical axis thereof, so that the second lens (520) has a negative refractive power around the optical axis thereof. The fifth surface (531) of the third lens (530) is selected to be a concave surface around the optical axis thereof, and the sixth surface (532) in the third lens (530) is selected to be a convex surface around the optical axis thereof, so that the third lens (530) has a positive refractive power around the optical axis thereof. In addition, the seventh surface (541) of the fourth lens (540) is selected to be a convex surface around the optical axis thereof, and the eighth surface (542) of the fourth lens (540) is a wavy surface that concave around the optical axis thereof. Moreover, in to the second preferred embodiment of the disclosed thin imaging lens assembly with four lenses, the lenses forming the lens set (500) have their surfaces made with certain measures in terms of radius of curvature, thickness, interval, refractive index and Abbe number as shown in Table 3.

Table 4 shows the surface parameters for the preferred embodiment of the present invention made according to Table 3. Please refer to Table 4 for the definition of the aspherical curved surfaces of the foregoing thin imaging lens assembly with four lenses. More particularly, the aspherical coefficients are selected to have 16 as the highest order, so that the lens set of the disclosed thin imaging lens assembly with four lenses can realize the preferred embodiment as defined in Table 3.

Therefore, referring to FIG. 6, FIG. 7 and FIG. 8, according to the preferred embodiment defined by the parameters as summarized in Table 3 and Table 4, the disclosed thin imaging lens assembly with four lenses is enhanced in terms of optical distortion, field curvature and optical aberration.

For the embodiment of the disclosed thin imaging lens assembly with four lenses of FIG. 5 made in accordance with the parameters listed in Table 3 and Table 4, these parameters are:

f=3.45 mm

TL=4.07 mm

Dg=5.2 mm

f/TL=0.85

TL/Dg=0.78

By combining the optical parameters, focal length ratios and geometric parameter ratios of the lenses appropriately, the optimal imaging performance can be achieved.

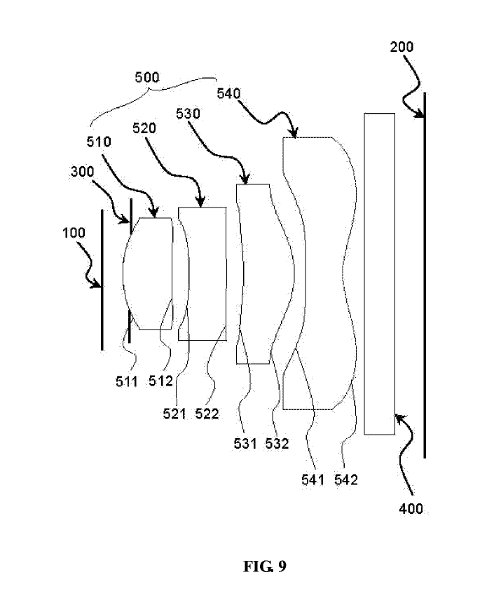

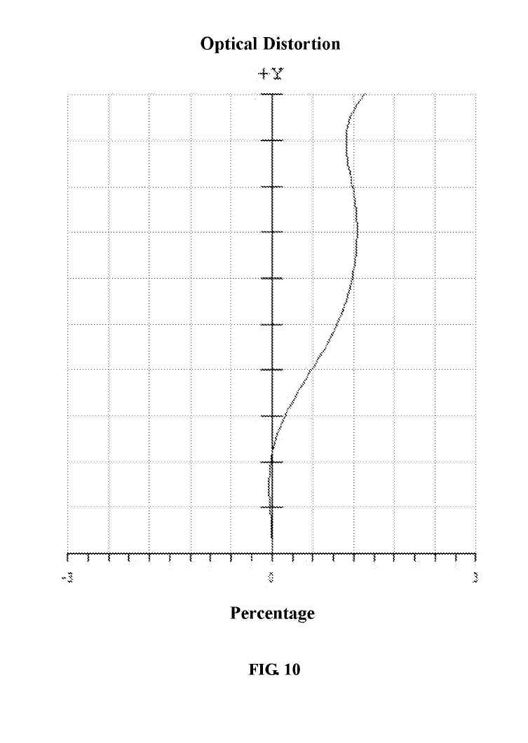

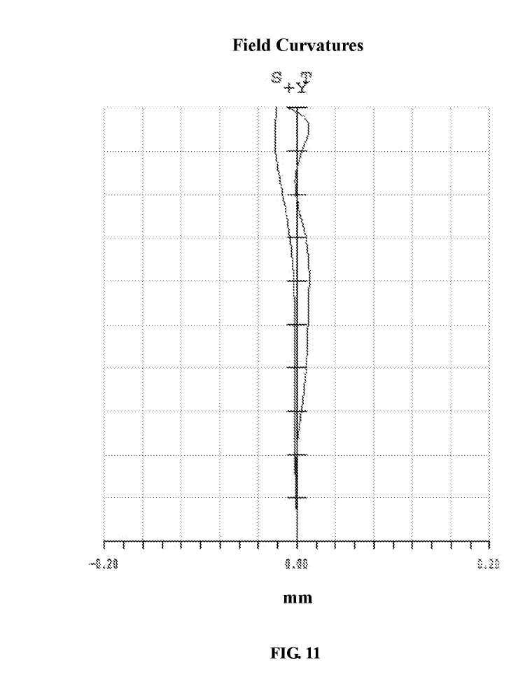

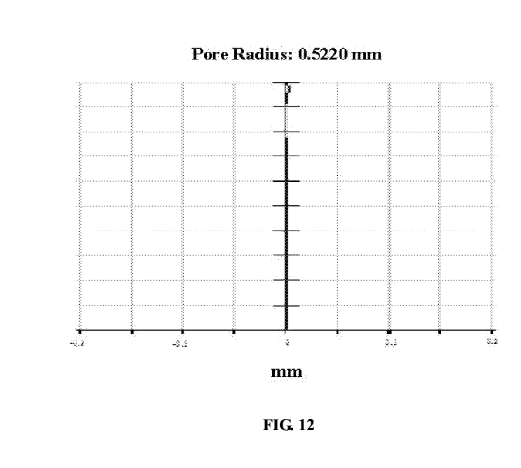

Table 5 shows lens parameters and performance indexes of the third preferred embodiment of the disclosed thin imaging lens assembly with four lenses. FIG. 9 depicts the structure of the third preferred embodiment of the disclosed thin imaging lens assembly with four lenses. FIG. 10 graphs the optical distortion of the preferred embodiment of the present invention made according to the parameters listed in Table 5. FIG. 11 the field curvatures of the preferred embodiment of the present invention made according to the parameters listed in Table 5. FIG. 12 graphs the optical aberration of the preferred embodiment of the present invention made according to the parameters listed in Table 5. Referring to Table 5 and FIG. 9, according to a further embodiment of the disclosed thin imaging lens assembly with four lenses, the fixed aperture (300) may be deposited between the first surface (511) of the first lens (510) and the object side (100). The first surface (511) of the first lens (510) is selected to be a convex surface around the optical axis thereof, and the second surface (512) is selected to be a concave surface around the optical axis thereof, so that the first lens (510) has a positive refractive power around the optical axis thereof. The third surface (521) of the second lens (520) is selected to be a concave surface around the optical axis thereof, and the fourth surface (522) of the second lens (520) is selected to be a convex surface around the optical axis thereof, so that the second lens (520) has a negative refractive power around the optical axis thereof. The fifth surface (531) of the third lens (530) is selected to be a concave surface around the optical axis thereof, and the sixth surface (532) of the third lens (530) is selected to be a convex surface around the optical axis thereof, so that the third lens (530) has a positive refractive power around the optical axis thereof. Additionally, the seventh surface (541) of the fourth lens (540) is selected to be a convex surface around the optical axis thereof, and the eighth surface (542) of the fourth lens (540) is a wavy surface that is concave around the optical axis thereof. Furthermore, according to the third preferred embodiment of the present invention, in the disclosed thin imaging lens assembly with four lenses, the lenses forming the lens set (500) have their surfaces made with certain measures in terms of radius of curvature, thickness, interval, refractive index and Abbe number as shown in Table 5.

Table 6 shows the surface parameters for the preferred embodiment of the present invention made according to Table 5. Please refer to Table 6 for the definition of the aspherical curved surfaces of the foregoing thin imaging lens assembly with four lenses. More particularly, the aspherical coefficients are selected to have 16 as the highest order, so that the lens set of the disclosed thin imaging lens assembly with four lenses can realize the preferred embodiment as defined in Table 5.

Therefore, referring to FIG. 10, FIG. 11 and FIG. 12, according to the preferred embodiment defined by the parameters as summarized in Table 5 and Table 6, the disclosed thin imaging lens assembly with four lenses is enhanced in terms of optical distortion, field curvature and optical aberration.

For the preferred embodiment of the disclosed thin imaging lens assembly with four lenses of FIG. 9 made in accordance with the parameters listed in Table 5 and Table 6, these parameters are:

f=2.5 mm

TL=3.07 mm

Dg=3.52 mm

f/TL=0.81

TL/Dg=0.87

By combining the optical parameters, focal length ratios and geometric parameter ratios of the lenses appropriately, the optimal imaging performance can be achieved.

While In the said embodiments the aspherical coefficients are selected to have 16 as the highest order, it is to be understood that so that the highest order of the aspherical coefficients is not limited to 16.

The above description of the present invention is intended only to illustrate the preferred embodiments but not to limit the scope of the present invention. It is understood that equivalent changes and modifications of the above embodiments can be made without departing from the spirit of the present invention. The scope of the present invention is defined only by the appended claims.

TABLE 1

| Surface | | Radius | Thickness | Nd | Vd |
|---|---|---|---|---|---|
| first | first | 2.15 | 0.92 | 1.544100 | 56.093602 |
| lens(510) | surface(511) | | | | |
| | second | 11.38 | 0.05 | | |
| | surface(512) | | | | |
| second | third | −5.78 | 0.81 | 1.635500 | 23.891420 |
| lens(520) | surface (521) | | | | |
| | fourth | −50.92 | 0.12 | | |
| | surface(522) | | | | |
| third | fifth | −5.79 | 1.12 | 1.544100 | 56.093602 |
| lens(530) | surface(531) | | | | |
| | sixth | −1.12 | 0.12 | | |
| | surface(532) | | | | |
| fourth | seventh | 31.61 | 0.72 | 1.534611 | 56.072163 |
| lens(540) | surface(541) | | | | |
| | eighth | 1.20 | 0.44 | | |
| | surface(542) | | | | |

TABLE 2

| Surface | | k | A | B | C | D | E | F | G |
|---|---|---|---|---|---|---|---|---|---|
| first | first | 0.18 | 5.01307E−03 | −9.11542E−03 | −4.66261E−03 | 1.19396E−02 | −6.22948E−03 | −6.25946E−04 | 5.67456E−04 |
| lens | surface(511) | | | | | | | | |
| (510) | second | 40.8 | −6.71416E−03 | −4.42110E−02 | 9.01705E−02 | −1.47952E−01 | 1.89611E−01 | −2.15432E−01 | 1.11385E−01 |
| | surface(512) | | | | | | | | |
| second | third | 10.81 | −6.66848E−02 | −1.23023E−02 | 5.31830E−02 | −6.54202E−02 | 1.23888E−03 | 4.94278E−02 | −3.32726E−02 |
| lens | surface(521) | | | | | | | | |
| (520) | fourth | −438.79 | −2.87772E−02 | 1.95654E−02 | −2.37692E−02 | 1.00235E−02 | 2.17491E−03 | −2.68091E−03 | 4.66706E−04 |
| | surface(522) | | | | | | | | |
| third | fifth | 8.19 | 3.05878E−02 | −4.31474E−03 | −5.20548E−03 | 3.36980E−03 | 1.10494E−04 | −3.86087E−04 | 1.65611E−05 |
| lens | surface(531) | | | | | | | | |
| (530) | sixth | −3.44 | −3.44431E−02 | 1.34124E−02 | −3.25029E−03 | 1.18720E−03 | 3.01063E−06 | −5.27455E−05 | 4.60757E−06 |
| | surface(532) | | | | | | | | |
| fourth | seventh | 133.05 | −4.35182E−02 | 3.75255E−03 | 9.43237E−05 | 1.98336E−05 | 5.67586E−07 | −8.33623E−07 | 3.56142E−08 |
| lens | surface(541) | | | | | | | | |
| (540) | eighth | −6.32 | −3.36232E−02 | 7.43149E−03 | −1.39199E−03 | 1.26368E−04 | −1.58546E−06 | −5.82698E−07 | 2.93135E−08 |
| | surface(542) | | | | | | | | |

TABLE 3

| Surface | | Radius | Thickness | Nd | Vd |
|---|---|---|---|---|---|
| first | first | 1.16 | 0.55 | 1.534611 | 56.072163 |
| lens(510) | surface(511) | | | | |
| | second | 4.02 | 0.05 | | |
| | surface(512) | | | | |
| second | third | −1.51 | 0.32 | 1.635500 | 23.891420 |
| lens(520) | surface(521) | | | | |
| | fourth | −2.23 | 0.31 | | |
| | surface( 522) | | | | |
| third | fifth | −4.66 | 0.37 | 1.534611 | 56.072163 |
| lens(530) | surface(531) | | | | |
| | sixth | −1.30 | 0.03 | | |
| | surface(532) | | | | |
| fourth | seventh | 5.07 | 0.51 | 1.534611 | 56.072163 |
| lens(540) | surface(541) | | | | |
| | eighth | 1.12 | 0.19 | | |
| | surface(542) | | | | |

TABLE 4

| Surface | | k | A | B | C | D | E | F | G |
|---|---|---|---|---|---|---|---|---|---|
| first | first | 0.49 | −3.53595E−02 | −3.93325E−02 | 4.76832E−02 | −6.28181E−01 | 1.10840E+00 | −7.32254E−01 | −3.89687E−01 |
| lens(510) | surface(511) | | | | | | | | |
| | second | 37.32 | −8.49647E−02 | −3.05538E−01 | 7.79996E−01 | −5.54961E+00 | 2.22597E−01 | −6.24834E+01 | 6.16827E+01 |
| | surface(512) | | | | | | | | |
| second | third | 3.53 | −3.01073E−01 | 5.17869E−01 | 3.04050E−02 | −5.56318E+00 | 1.38019E+01 | 1.65235E+01 | −4.47376E+01 |
| lens(520) | surface(521) | | | | | | | | |
| | fourth | 4.19 | −3.78921E−01 | 7.12336E−01 | −9.67415E−01 | 8.32263E−01 | 7.69609E−02 | 1.49719E+00 | −1.72519E+00 |
| | surface(522) | | | | | | | | |
| third | fifth | 12.87 | −3.62969E−02 | 4.83035E−02 | −6.08841E−02 | −2.01799E−02 | −6.52893E−03 | 4.54922E−02 | −1.39143E−02 |
| lens(530) | surface(531) | | | | | | | | |
| | sixth | −10.4 | 4.94496E−02 | 7.04913E−02 | −1.19842E−01 | 3.96473E−02 | 9.08982E−03 | −7.36256E−03 | 1.03426E−03 |
| | surface(532) | | | | | | | | |
| fourth | seventh | −13.7 | −1.41670E−01 | 6.11450E−02 | −6.78012E−03 | −1.49710E−03 | 2.02370E−04 | 1.05895E−04 | −2.11900E−05 |
| lens(540) | surface(541) | | | | | | | | |
| | eighth | −9.14 | −1.13341E−01 | 4.54754E−02 | −1.80460E−02 | 3.14506E−03 | 4.73630E−05 | −5.92310E−05 | 3.42700E−06 |
| | surface(542) | | | | | | | | |

TABLE 5

| Surface | | Radius | Thickness | Nd | Vd |
|---|---|---|---|---|---|
| first | first | 0.95 | 0.48 | 1.534611 | 56.072163 |
| lens(510) | surface(511) | | | | |
| | second | 7.72 | 0.17 | | |
| | surface(512) | | | | |
| second | third | −2.36 | 0.36 | 1.631920 | 23.415236 |
| lens(520) | surface(521) | | | | |
| | fourth | −5.76 | 0.17 | | |
| | surface(522) | | | | |
| third | fifth | −1.76 | 0.50 | 1.534611 | 56.072163 |
| lens(530) | surface(531) | | | | |
| | sixth | −0.69 | 0.10 | | |
| | surface(532) | | | | |
| fourth | seventh | 8.34 | 0.36 | 1.534611 | 56.072163 |
| lens(540) | surface(541) | | | | |
| | eighth | 0.70 | 0.21 | | |
| | surface(542) | | | | |

TABLE 6

| Surface | | k | A | B | C | D | E | F | G |
|---|---|---|---|---|---|---|---|---|---|
| first | first surface(511) | 0.02 | 60.52 | −73.69 | 25.71 | 4.78 | −3.96 | −1253.48 | −7.13 |
| lens(510) | second surface(512) | 0.006686 | 0.01018 | −0.66231 | 0.554379 | 0.946705 | −0.10664 | −0.58595 | −0.37173 |
| second | third surface(521) | 0.230343 | −1.43534 | 0.796485 | −0.78845 | −0.62203 | 0.518594 | 0.02947 | 0.312721 |
| lens(520) | fourth surface(522) | −0.40256 | 8.977374 | −7.96239 | −2.98748 | −1.36014 | −0.36988 | 0.071224 | −0.20131 |
| third | fifth surface(531) | −7.99235 | −70.3131 | 40.66613 | 9.22181 | 2.854516 | 0.335346 | −0.0029 | 0.065539 |
| lens(530) | sixth surface(532) | 63.2978 | 297.1864 | −216.96 | 7.11727 | 0.800868 | −0.08745 | −0.0102 | −0.00301 |
| fourth | seventh surface(541) | −185.839 | −732.19 | 605.2154 | −55.4587 | −6.4188 | −0.37317 | −0.0128 | −0.00512 |
| lens(540) | eighth surface(542) | 178.0738 | 666.068 | −778.956 | 63.27212 | 5.59621 | 0.203332 | −0.00277 | 0.001042 |

What is claimed is:

1. A thin imaging lens assembly with four lenses, having one defined as an object side and an opposite end defined as an image side, and comprising:
a lens set, including a first lens, a second lens, a third lens, and a fourth lens that are arranged from the object side to the image side in sequence so as to form an optical structure; and
a fixed aperture, deposited between the object side and the image side, wherein
the first lens has a positive refractive power around an optical axis thereof and comprises a first surface and a second surface, in which the first surface and the second surface are curved surfaces facing the object side and the image side, respectively, while the second surface is concave surface around an optical axis thereof; the second lens has a negative refractive power around an optical axis thereof and comprises a third surface and a fourth surface, in which the third surface and the fourth surface are curved surfaces facing the object side and the image side, respectively, while the fourth surface is a convex surface around an optical axis thereof; the third lens has a positive refractive power around an optical axis thereof and comprises a fifth surface and a sixth surface, in which the fifth surface and the sixth surface are curved surfaces facing the object side and the image side, respectively, while the fifth surface is a concave surface around an optical axis thereof; and the fourth lens comprises a seventh surface and an eighth surface, in which the seventh surface and eighth surface are curved surface facing the object side and the image side, respectively, while the seventh surface is a convex surface around an optical axis thereof and the eighth surface is wavy and is concave around an optical axis thereof.

2. The thin imaging lens assembly with four lenses of claim 1, wherein each of the first lens, the second lens, the third lens and the fourth lens has at least one said surface being an aspherical surface.

3. The thin imaging lens assembly with four lenses of claim 1, wherein each of the first lens, the second lens, the third lens and the fourth lens has at least one said surface being a spherical curved surface.

4. The thin imaging lens assembly with four lenses of claim 1, wherein the first surface of the first lens is a convex surface around an optical axis thereof, and radius of curvatures of the first surface and the second surface are such configured that the first lens has the positive refractive power around the optical axis thereof.

5. The thin imaging lens assembly with four lenses of claim 1, wherein the third surface of the second lens is a concave surface around an optical axis thereof, and radius of curvatures of the third surface and the fourth surface are such configured that the second lens has the negative refractive power around the optical axis thereof.

6. The thin imaging lens assembly with four lenses of claim 1, wherein the sixth surface of the third lens is a convex surface around an optical axis thereof, and radius of curvatures of the fifth surface and the sixth surface are such configured that the third lens has the positive refractive power around the optical axis thereof.

7. The thin imaging lens assembly with four lenses of claim 1, wherein a focal length of the entire lens set is f, and a distance between the first surface of the first lens and the image side is TL, in which 0.5<f/TL<1.

8. The thin imaging lens assembly with four lenses of claim 1, and 0.5<TL/Dg<1, in which Dg is defined as a diagonal length of a maximum using visual angle of the lens assembly imaged on the image side.

9. The thin imaging lens assembly with four lenses of claim 1, wherein further comprising a filter this is a band-pass optical lens and located between the object side and the image side.

10. The thin imaging lens assembly with four lenses of claim 9, further comprising a filter, which is a band-pass optical lens and deposited at one side of the fourth lens facing the image side.

11. The thin imaging lens assembly with four lenses of claim 1, wherein the fixed aperture is deposited on one of the surfaces of one of the lenses.
